(19) United States
(12) Patent Application Publication
(10) Pub. No.: US 2018/0349135 A1
(43) Pub. Date: Dec. 6, 2018

(54) SOFTWARE DEVELOPMENT PROJECT SYSTEM AND METHOD

(71) Applicants: WILLIAM R. BURNS, Brick, NJ (US); Joseph McGovem, Sewell, NJ (US); Lisa Rodriguez, Ormond Beach, FL (US); Henry Rodriguez, Ormond Beach, FL (US)

(72) Inventors: WILLIAM R. BURNS, Brick, NJ (US); Joseph McGovem, Sewell, NJ (US); Lisa Rodriguez, Ormond Beach, FL (US); Henry Rodriguez, Ormond Beach, FL (US)

(21) Appl. No.: 15/997,345

(22) Filed: Jun. 4, 2018

Related U.S. Application Data
(60) Provisional application No. 62/514,387, filed on Jun. 2, 2017.

(51) Int. Cl. G06F 8/77; G06F 17/50

(52) U.S. Cl. CPC G06F 8/77; G06F 2217/16; G06F 17/5009

(57) ABSTRACT

A method, computer program product, and computer system for receiving, at a computing device, a plurality of development requirements of a software development project. A plurality of possible results for one or more development factors estimated to complete the software development project may be generated based upon, at least in part, the plurality of development requirements for the software development project. A plurality of results for the one or more development factors estimated to complete the software development project may be generated and may include processing a different set of random values from the plurality of possible results for the one or more development factors estimated to complete the software development project during each iteration of a plurality of iterations of one or more probabilistic models. The plurality of results for the one or more development factors may be provided in a user interface.

### RELATED CASES

This application claims the benefit of U.S. Provisional Application No. 62/514,387, filed on 2 Jun. 2017, the contents of which are all incorporated by reference.

### BACKGROUND

In Agile software development, requirements and solutions evolve through collaboration by self-organizing cross-functional teams of analysts, developers, testers, and configuration managers. Conventional Agile software development has relied on deterministic methodologies to manage and estimate resources required to complete a software development project. Additionally, conventional agile software development solutions have been unable to use measurable project objectives to meet needs of customers, end-users, and organizations according to the requirements for Capability Maturity Model Integration (CMMI) Level 4.

### BRIEF SUMMARY OF DISCLOSURE

In one example implementation, a method, performed by one or more computing devices, may include but is not limited to receiving, at a computing device, a plurality of development requirements of a software development project. A plurality of possible results for one or more development factors estimated to complete the software development project may be generated based upon, at least in part, the plurality of development requirements for the software development project. A plurality of results for the one or more development factors estimated to complete the software development project may be generated and may include processing a different set of random values from the plurality of possible results for the one or more development factors estimated to complete the software development project during each iteration of a plurality of iterations of one or more probabilistic models. The plurality of results for the one or more development factors estimated to complete the software development project may be provided in a user interface of the computing device.

One or more of the following example features may be included. One or more revised development requirements may be received in response to providing the plurality of results for the one or more development factors estimated to complete the software development project in the user interface of the computing device. A plurality of revised possible results for the one or more development factors estimated to complete the software development project may be generated based upon, at least in part, the plurality of revised development requirements for the software development project. A plurality of revised results for the one or more development factors estimated to complete the software development project may be generated and may include processing a different set of random values from the plurality of revised possible results for the one or more development factors estimated to complete the software development project during each iteration of the plurality of iterations of the one or more probabilistic models. The plurality of results for the one or more development factors estimated to complete the software development project may be provided in a user interface of the computing device. The one or more development factors estimated to complete the software development project may include one or more of: requirements points, velocity, defects created, defect points, total sprints, and velocity increase. One or more of a lower control limit and an upper control limit may be defined based upon, at least in part, historical software development project data. A minimum level of confidence associated with completing the software development project for a set of development factors estimated to complete the software development project may be received based upon, at least in part, the plurality of development requirements for the software development project. The plurality of results for the one or more development factors estimated to complete the software development project may be generated based upon, at least in part, the minimum level of confidence associated with completing the software development project with the set of development factors. The one or more probabilistic models may include one or more Monte Carlo simulations. At least one of the one or more development factors may be weighted with a probability weight specific to each development factor.

In another example implementation, a computing system may include one or more processors and one or more memories configured to perform operations that may include but are not limited to receiving, at a computing device, a plurality of development requirements of a software development project. A plurality of possible results for one or more development factors estimated to complete the software development project may be generated based upon, at least in part, the plurality of development requirements for the software development project. A plurality of results for the one or more development factors estimated to complete the software development project may be generated and may include processing a different set of random values from the plurality of possible results for the one or more development factors estimated to complete the software development project during each iteration of a plurality of iterations of one or more probabilistic models. The plurality of results for the one or more development factors estimated to complete the software development project may be provided in a user interface of the computing device.

One or more of the following example features may be included. One or more revised development requirements may be received in response to providing the plurality of results for the one or more development factors estimated to complete the software development project in the user interface of the computing device. A plurality of revised possible results for the one or more development factors estimated to complete the software development project may be generated based upon, at least in part, the plurality of revised development requirements for the software development project. A plurality of revised results for the one or more development factors estimated to complete the software development project may be generated and may include processing a different set of random values from the plurality of revised possible results for the one or more development factors estimated to complete the software development project during each iteration of the plurality of iterations of the one or more probabilistic models. The plurality of results for the one or more development factors estimated to complete the software development project may be provided in a user interface of the computing device. The one or more development factors estimated to complete the software development project may include one or more of: requirements points, velocity, defects created, defect points, total sprints, and velocity increase. One or more of a lower control limit and an upper control limit may be defined based upon, at least in part, historical software development project data. A minimum level of confidence associated with completing the software development project for a set of development factors estimated to complete the software development project may be received based upon, at least in part, the plurality of development requirements for the software development project. The plurality of results for the one or more development factors estimated to complete the software development project may be generated based upon, at least in part, the minimum level of confidence associated with completing the software development project with the set of development factors. The one or more probabilistic models may include one or more Monte Carlo simulations. At least one of the one or more development factors may be weighted with a probability weight specific to each development factor.

In another example implementation, a computer program product may reside on a computer readable storage medium having a plurality of instructions stored thereon which, when executed across one or more processors, may cause at least a portion of the one or more processors to perform operations that may include but are not limited to receiving, at a computing device, a plurality of development requirements of a software development project. A plurality of possible results for one or more development factors estimated to complete the software development project may be generated based upon, at least in part, the plurality of development requirements for the software development project. A plurality of results for the one or more development factors estimated to complete the software development project may be generated and may include processing a different set of random values from the plurality of possible results for the one or more development factors estimated to complete the software development project during each iteration of a plurality of iterations of one or more probabilistic models. The plurality of results for the one or more development factors estimated to complete the software development project may be provided in a user interface of the computing device.

One or more of the following example features may be included. One or more revised development requirements may be received in response to providing the plurality of results for the one or more development factors estimated to complete the software development project in the user interface of the computing device. A plurality of revised possible results for one or more development factors estimated to complete the software development project may be generated based upon, at least in part, the plurality of revised development requirements for the software development project. A plurality of revised results for the one or more development factors estimated to complete the software development project may be generated and may include processing a different set of random values from the plurality of revised possible results for the one or more development factors estimated to complete the software development project during each iteration of the plurality of iterations of the one or more probabilistic models. The plurality of results for the one or more development factors estimated to complete the software development project may be provided in a user interface of the computing device. The one or more development factors estimated to complete the software development project may include one or more of: requirements points, velocity, defects created, defect points, total sprints, and velocity increase. One or more of a lower control limit and an upper control limit may be defined based upon, at least in part, historical software development project data. A minimum level of confidence associated with completing the software development project for a set of development factors estimated to complete the software development project may be received based upon, at least in part, the plurality of development requirements for the software development project. The plurality of results for the one or more development factors estimated to complete the software development project may be generated based upon, at least in part, the minimum level of confidence associated with completing the software development project with the set of development factors. The one or more probabilistic models may include one or more Monte Carlo simulations. At least one of the one or more development factors may be weighted with a probability weight specific to each development factor.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a software development process coupled to an example distributed computing network according to one or more example implementations of the disclosure;

FIG. 2 is an example flowchart of a software development process according to one or more example implementations of the disclosure;

FIG. 3 is an example diagrammatic view of development requirements according to one or more example implementations of the disclosure;

FIG. 4 is an example diagrammatic view of software development process according to one or more example implementations of the disclosure;

FIG. 5 is an example diagrammatic view of at least a portion of software development process for generating results for the development factor of “requirement points” according to one or more example implementations of the disclosure;

FIG. 6 is an example diagrammatic view of at least a portion of software development process for generating results for the development factor of “velocity” according to one or more example implementations of the disclosure;

FIG. 7 is an example diagrammatic view of at least a portion of software development process for generating results for the development factor of “defects created” according to one or more example implementations of the disclosure;

FIG. 8 is an example diagrammatic view of at least a portion of software development process for generating results for the development factor of “defects points” according to one or more example implementations of the disclosure;

FIG. 9 is an example diagrammatic view of at least a portion of software development process for generating results for the development factor of “total sprints” according to one or more example implementations of the disclosure;

FIG. 10 is an example diagrammatic view of at least a portion of software development process for generating results for the development factor of “velocity increase” according to one or more example implementations of the disclosure;

FIG. 11 is an example diagrammatic view of results of one or more development factors provided via a user interface according to one or more example implementations of the disclosure;

FIG. 12 is an example diagrammatic view of a control chart according to one or more example implementations of the disclosure;

FIG. 13 is an example diagrammatic view of sample data table and control chart to compare actual performance against project performance baselines according to one or more example implementations of the disclosure; and

FIG. 14 is an example diagrammatic view of a computer of FIG. 1 according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

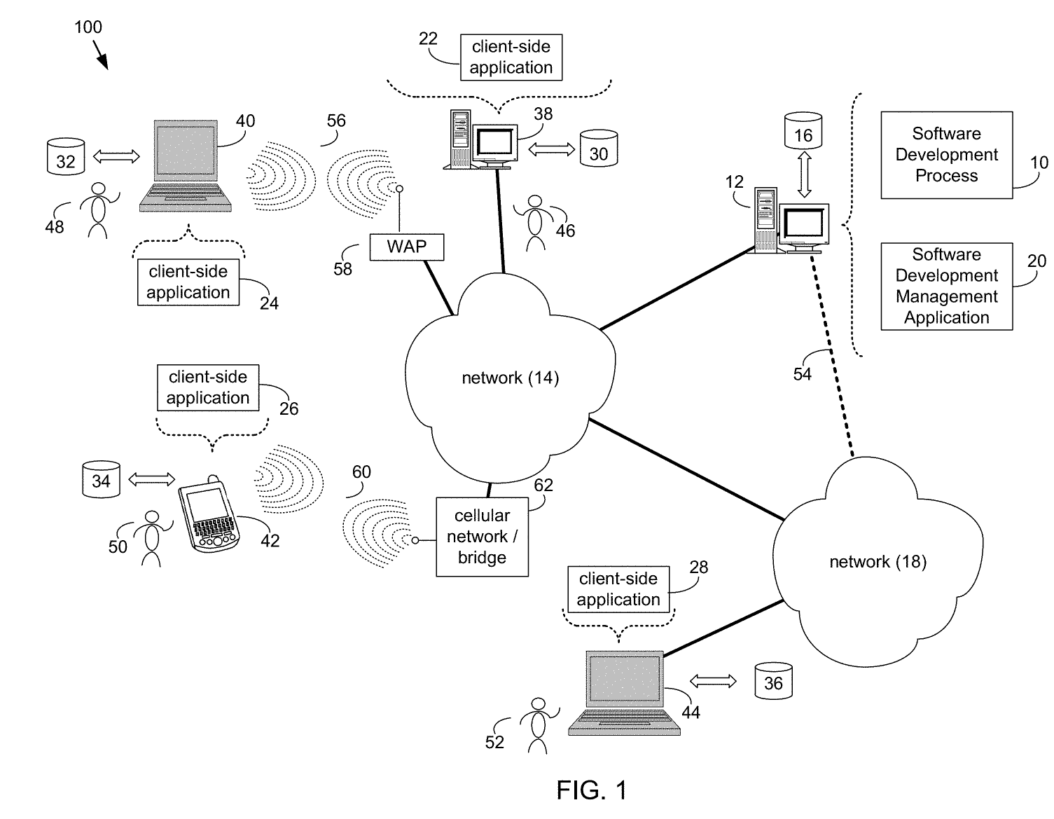

Referring now to the example implementation of FIG. 1, there is shown software development process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an software development process, such as software development process 10 of FIG. 1, may include receiving 200, at a computing device, a plurality of development requirements of a software development project. Software development process 10 may generate 202 a plurality of possible results for one or more development factors estimated to complete the software development project based upon, at least in part, the plurality of development requirements for the software development project. Software development process 10 may generate 204 a plurality of results for the one or more development factors estimated to complete the software development project including processing a different set of random values from the plurality of possible results for the one or more development factors estimated to complete the software development project during each iteration of a plurality of iterations of one or more probabilistic models. Software development process 10 may provide 206 the plurality of results for the one or more development factors estimated to complete the software development project in a user interface of the computing device.

In some implementations, the instruction sets and subroutines of software development process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, software development process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a client application (e.g., software development management application 20), examples of which may include, but are not limited to, e.g., an agile software management applications (e.g., IBM® Rational Jazz tool suite) and/or other software development project management application. In some implementations, software development process 10 and/or software development management application 20 may be accessed via one or more of client applications 22, 24, 26, 28. In some implementations, software development process 10 may be a standalone application, or may be an applet/application/script/extension that may interact with and/or be executed within software development management application 20, a component of software development management application 20, and/or one or more of client applications 22, 24, 26, 28. In some implementations, software development management application 20 may be a standalone application, or may be an applet/application/script/extension that may interact with and/or be executed within software development process 10, a component of software development process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of software development process 10 and/or software development management application 20. Examples of client applications 22, 24, 26, 28 may include, but are not limited to, e.g., an agile software management applications (e.g., IBM Rational Jazz tool suite) and/or other software development project management application, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of software development process 10 (and vice versa). Accordingly, in some implementations, software development process 10 may be a purely server-side application, a purely client-side application, or a hybrid server-side/client-side application that is cooperatively executed by one or more of client applications 22, 24, 26, 28 and/or software development process 10.

In some implementations, one or more of client applications 22, 24, 26, 28 may be configured to effectuate some or all of the functionality of software development management application 20 (and vice versa). Accordingly, in some implementations, software development management application 20 may be a purely server-side application, a purely client-side application, or a hybrid server-side/client-side application that is cooperatively executed by one or more of client applications 22, 24, 26, 28 and/or software development management application 20. As one or more of client applications 22, 24, 26, 28, software development process 10, and software development management application 20, taken singly or in any combination, may effectuate some or all of the same functionality, any description of effectuating such functionality via one or more of client applications 22, 24, 26, 28, software development process 10, software development management application 20, or combination thereof, and any described interaction(s) between one or more of client applications 22, 24, 26, 28, software development process 10, software development management application 20, or combination thereof to effectuate such functionality, should be taken as an example only and not to limit the scope of the disclosure.

In some implementations, one or more of users 46, 48, 50, 52 may access computer 12 and software development process 10 (e.g., using one or more of client electronic devices 38, 40, 42, 44) directly through network 14 or through secondary network 18. Further, computer 12 may be connected to network 14 through secondary network 18, as illustrated with phantom link line 54. Software development process 10 may include one or more user interfaces, such as browsers and textual or graphical user interfaces, through which users 46, 48, 50, 52 may access software development process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

As will be discussed below, software development process 10 may at least help, e.g., improve financial and structured media product technology processes, which are necessarily rooted in computer technology in order to overcome an example and non-limiting problem specifically arising in the realm of machine learning based generation of financial and structured media products). It will be appreciated that the computer processes described throughout are not considered to be well-understood, routine, and conventional functions.

The Software Development Process:

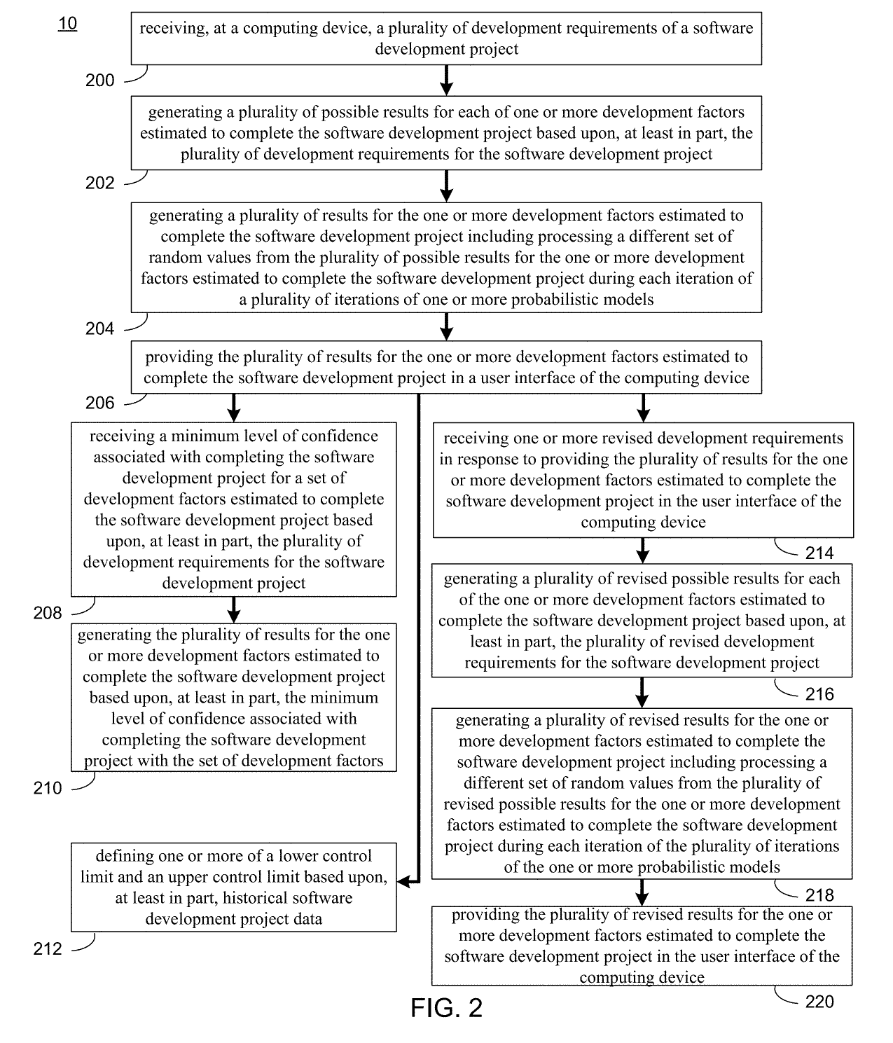

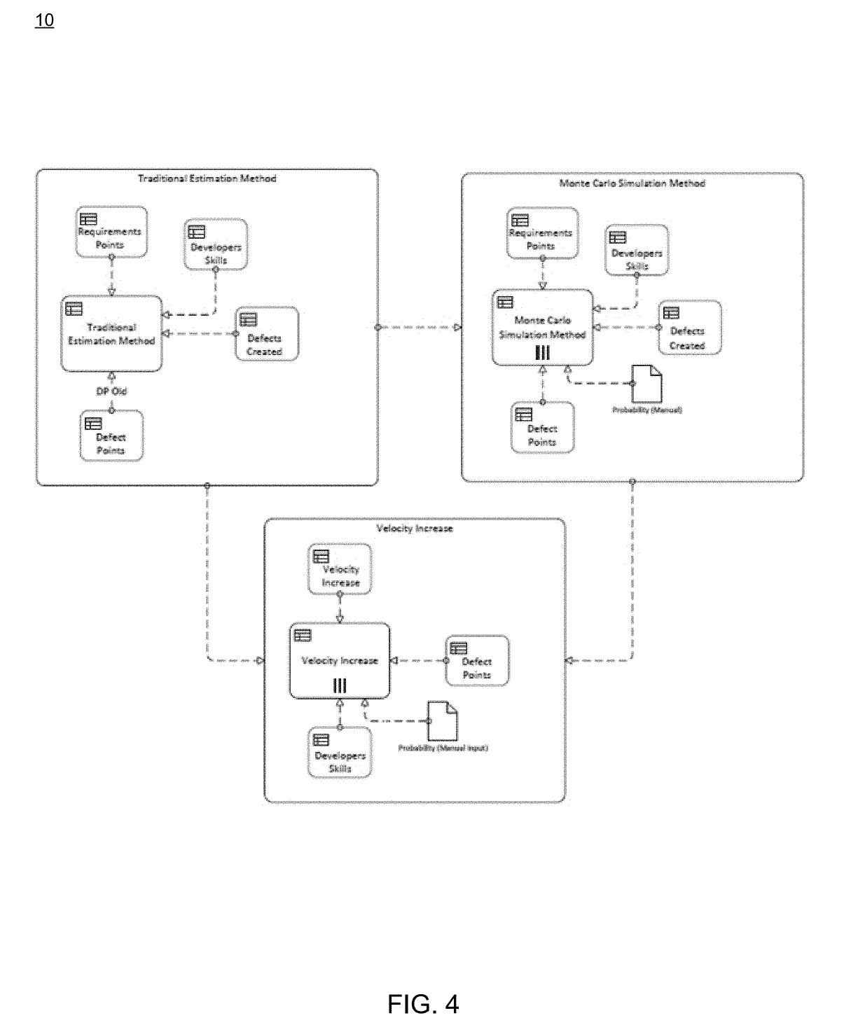

As discussed above and referring also at least to the example implementations of FIGS. 2-14, software development process 10 may receive 200, at a computing device, a plurality of development requirements of a software development project. Software development process 10 may generate 202 a plurality of possible results for one or more development factors estimated to complete the software development project based upon, at least in part, the plurality of development requirements for the software development project. Software development process 10 may generate 204 a plurality of results for the one or more development factors estimated to complete the software development project including processing a different set of random values from the plurality of possible results for the one or more development factors estimated to complete the software development project during each iteration of a plurality of iterations of one or more probabilistic models. Software development process 10 may provide 206 the plurality of results for the one or more development factors estimated to complete the software development project in a user interface of the computing device.

As will be discussed in greater detail below, software development process 10 may provide estimates or results for one or more software development factors necessary to complete a software development project for a plurality of development requirements. For example and as will be discussed in greater detail below, software development process 10 may provide probabilistic results for the one or more development factors estimated to complete the software development project. This is in contrast to conventional or traditional approaches to estimating or predicting activities and steps necessary to complete a software development project. For example, these conventional or traditional approaches are deterministic, meaning a software development project with certain development requirements will always utilize or require the same development factors to complete the software development project. In contrast, software development process 10 includes providing results for the one or more development factors estimated to complete the project probabilistically, meaning a software development project with certain development requirements may utilize or require a range of possible development factors to complete the software development project. In this manner, software development process 10 may provide users (e.g., project managers) with a much more comprehensive view of not only what could happen but how likely it is to happen for varying levels of confidence or degrees of certainty.

In some embodiments, software development process 10 may allow software development planning compliant with the requirements of CMMI Level 4. For example, Capability Maturity Model Integration (CMMI) is a process level improvement program to increase performance levels in areas such as cost, schedule, productivity, quality and customer satisfaction. CMMI models may provide guidance for developing and improving processes that meet the business goals of an organization. CMMI defines five maturity levels: Initial, Managed, Defined, Quantitatively Managed and Optimizing. At Level 3, projects tailor their processes from the organization's defined standards, whereas in Level 4, processes are quantitatively measured and controlled. Level 4 consists of the Organizational Process Performance (OPP) and Quantitative Project Management (QPM) process areas. To achieve CMMI Level 4, organizations may use measurable project objectives to meet the needs of their customers, end-users and the organization. Project managers (PMs) and engineers use project data with statistical and other quantitative techniques in managing processes and results. These techniques apply the principles of statistical process control (SPC) to address causes of process variation to improve performance. Processes may be selected for performance analysis based on several factors such as: impact on overall project performance (based on project history); information needs of corporate and customer stakeholders; process maturity; and/or availability of meaningful data, historical and current.

Applying CMMI Level 4 techniques to assess performance of processes on agile software development projects may involve applying structured, statistical measurement, analysis, planning and control to a software development process that is inherently highly flexible and agile. For example, in Agile software development, requirements and solutions evolve through the collaborative effort of self-organizing cross-functional teams of analysts, developers, testers and configuration managers. The Agile software development approach advocates adaptive planning, evolutionary development, early and continuous delivery, and flexibly responding to change.

In some embodiments and as will be discussed in greater detail below, software development process 10 may deliver quantitative information that is within acceptable boundaries of probability where a target may be within +/−0.10 against actuals. The information used to develop and prove software development process 10 are based on the last five years of software application projects spanning new development, sustainment, maintenance and DevOps.

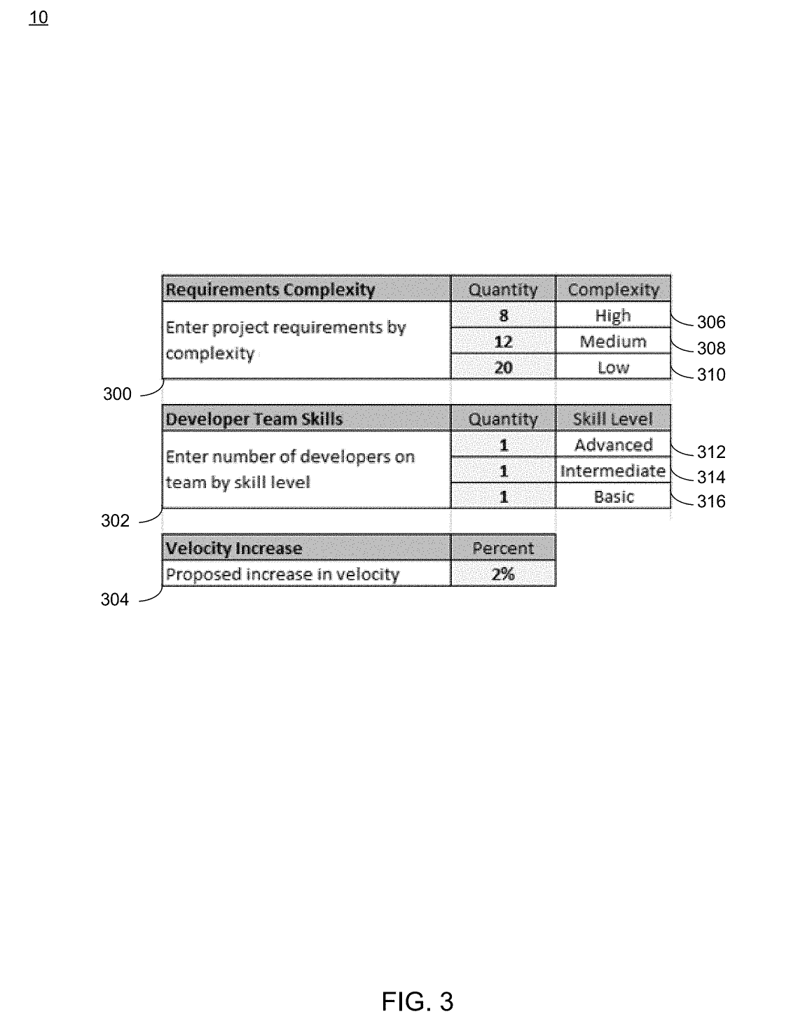

In some implementations, software development process 10 may receive 200, at a computing device, a plurality of development requirements of a software development project. For example and referring also to FIG. 3, software development process 10 may 200 a plurality of development requirements (e.g., development requirements 300, 302, 304). Development requirements may generally include controllable inputs or resources of a project. For example, development requirement 300 may include a number of project requirements. In some embodiments, the number of project requirements may be a number of points equivalent to a pre-determined number of hours of development time. In one example, one project requirement point may represent approximately four hours of development time. While four hours has been approximated by the Applicants, it will be appreciated that other predetermined numbers of hours may be used within the scope of the present disclosure. In some embodiments, the number of project requirements 300 may be defined by complexity (e.g., a high complexity 306, a medium complexity 308, and a low complexity 310). In some implementations, high complexity project requirements may represent e.g., 13 points and may generally involve integration into multiple systems or a high degree of refactoring. High complexity project requirements 306 may be representative of areas of high uncertainty in the development of a software project. In some implementations, medium complexity project requirements 308 may represent e.g., 8 points and may generally involve development within specific boundaries and a clear definition of requirements. In some implementations, low complexity project requirements 310 may represent e.g., 1-2 points (e.g., less than a day) and may involve easily addressed development within e.g., the user interface and business layer.

In some embodiments, development requirement 300 may include a number of developer skill levels associated with the software development team. In some embodiments, the developer skill levels may be represented by e.g., three developer skill levels (e.g., advanced skill level 312, intermediate skill level 314, and basic skill level 316). The number of developers with an advanced skill level 312 may be representative of developers highly skilled in the coding or programming language of the target software project. These developers may have strong problem solving skills, design and architecture capabilities, and/or may be able to provide leadership. These developers may be experienced in similar areas of software development with an advanced understanding of database, application, and/or web development. In some implementations, the number of developers with intermediate skill level 314 may be representative of developers skilled in the coding or programming language and/or those capable of driving to completion with minimal oversight. These developers may have good problem solving skills and a solid understanding of database, application, and/or web development. The number of developers with a basic skill level 316 may be representative of developers who can do fundamental coding assignments with supervision. These developers may be capable of delivering unit test harnesses and may have some understanding of database, application, and/or web development.

In some embodiments, the plurality of development requirements may include a proposed increase in velocity. Velocity as used in the context of software development, may generally include points (i.e., project requirement points representative of a pre-determined number of hours of development time) per sprint (i.e., a set period of time during which specific work has to be completed and made ready for review). In this manner, software development process 10 may allow a user (e.g., project manager) to predict or estimate what impact a percentage increase in velocity would have on the software development project.

In some implementations, software development process 10 may generate 202 a plurality of possible results for one or more development factors estimated to complete the software development project based upon, at least in part, the plurality of development requirements for the software development project. In some embodiments, development factors may generally include factors that may indicate what resources may be required to complete a software development project. For example, software development process 10 may generate 202 a plurality of possible results for one or more development factors including, but not limited to, requirement points, velocity, defects created, defect points, total sprints, velocity increase, etc. It will be appreciated that other development factors may be used within the scope of the present disclosure. As discussed above, software development process 10 may provide probabilistic results for one or more development factors estimated to complete the software development project. In some embodiments, one or more development factors may have an inherent amount of uncertainty. For example, similar software projects that have the same numbers of skilled developers working on a software development project with a similar number of project requirements may experience different numbers of defects created or velocities. In this manner, software development process 10 may generate 202 a plurality of possible results for one or more development factors. In some embodiments, software development process 10 may generate one or more models of possible results for each of the development factors. In some embodiments, the plurality of possible results for the one or more development factors may include a probability distribution of values for each development factor. While six exemplary development factors have been discussed, it will be appreciated that other factors may be used within the scope of the present disclosure. For example, other development factors may be estimated based upon, at least in part, project data in areas such as AgileEVM®; requirements volatility; document quality; risks (internal/external); defect density; SAFe®; and/or ServiceNow® processes.

In some embodiments, software development process 10 may generate 204 a plurality of results for the one or more development factors estimated to complete the software development project including processing a different set of random values from the plurality of possible results for the one or more development factors estimated to complete the software development project during each iteration of a plurality of iterations of one or more probabilistic models. In some embodiments, software development process 10 may generate a pre-determined number e.g., 600 of probabilistic models or probabilistic model iterations/simulations to statistically incorporate uncertainty when predicting the outcomes or results of the one or more development factors of the software development project. While 600 iterations have been discussed, it will be appreciated that any number of probabilistic model iterations may be used within the scope of the present disclosure. In some embodiments, the more iterations that are run by software development process 10, the more likely or more accurate the projected outcome. In some embodiments, the one or more probabilistic models may include one or more Monte Carlo simulations. However, other probabilistic models may be used within the scope of the present disclosure.

In some embodiments, software development process 10 may generate 204 the plurality of results for the one or more development factors over and over, each time using a different set of random values from the probability functions. In this manner, software development process 10 may process a different set of random values from the plurality of possible results for each of the one or more development factors estimated to complete the software development project during a plurality of iterations of one or more probabilistic models. As discussed above, software development process 10 may generate 202 a plurality of possible results for each of one or more development factors as probability distributions for each development factor. By processing the plurality of possible results with different, random values for each iteration of the pre-determined number of iterations of the one or more probabilistic models, software development process 10 may provide a more realistic way of describing uncertainty in variables of a software development process. In some embodiments, software development process 10 may leverage a normal probability distribution or “bell curve”. Based on the e.g., six models, software development process 10 may define the mean or expected value and a standard deviation to describe the variation about the mean. In some embodiments, software development process 10 may provide to the user (e.g., a project manager) values in the middle or near the mean as the most likely to occur. As software development process 10 executes the plurality of iterations of the one or more probabilistic modes (e.g., Monte Carlo simulations), values may be sampled at random from the generated 202 probability distributions.

In some embodiments, software development process 10 may receive 208 a minimum level of confidence associated with completing the software development project for a set of development factors estimated to complete the software development project based upon, at least in part, the plurality of development requirements for the software development project. In some embodiments, the minimum level of confidence may be pre-determined (e.g., a default value), may be determined by a user (e.g., via a user interface), and/or may be automatically determined by software development process 10.

In some embodiments, software development process 10 may generate 210 the plurality of results for the one or more development factors estimated to complete the software development project based upon, at least in part, the minimum level of confidence associated with completing the software development project with the set of development factors. For example, suppose the user (e.g., project manager) sets the desired level of confidence to e.g., 85% and plans the agile software development project (using software development process 10), then the user will have an 85% level of confidence that the project will successfully complete within the determined number of e.g., development sprints required. The data areas software development process 10 addresses may cover areas such as project team's anticipated sprint velocity and the total number of sprints required to accomplish the total points for both the requirements and anticipated defects created. In some embodiments, software development process 10 may also calculate these values using the traditional deterministic method that a user (e.g., a project manager) would have typically calculated (e.g., using average values without uncertainty) for comparison to the simulations to understand the changes and degree of variance.

In some embodiments, software development process 10 may provide a description of the relationships among the measurable attributes of one or more processes or work products that is developed from historical process performance data and is used to predict future performance. For example, software development process 10 may provide results that are statistical or probabilistic (chance of occurrence) in nature rather than deterministic (past performance predicts the future performance), where embodiments of software development process consider uncertainty and predict the range of values in the outcome. In this manner, software development process 10 may aid in data analysis, performance monitoring and decision making on corrective actions to apply to the project. In some embodiments, software development process 10 may predict future performance based on process and sub process controllable factors. Accordingly, software development process 10 may allow “what if” analyses for planning, dynamic re-planning, or problem resolution. Software development process 10 may aid in planning, re-planning and performing “what if” analyses that goes beyond predicting schedule variance. Software development process 10 may also enables the user to determine whether the project is heading to high risk scenario based on factors beyond their control such as (unexpected staffing changes, inability to access environments or weather to name a few).

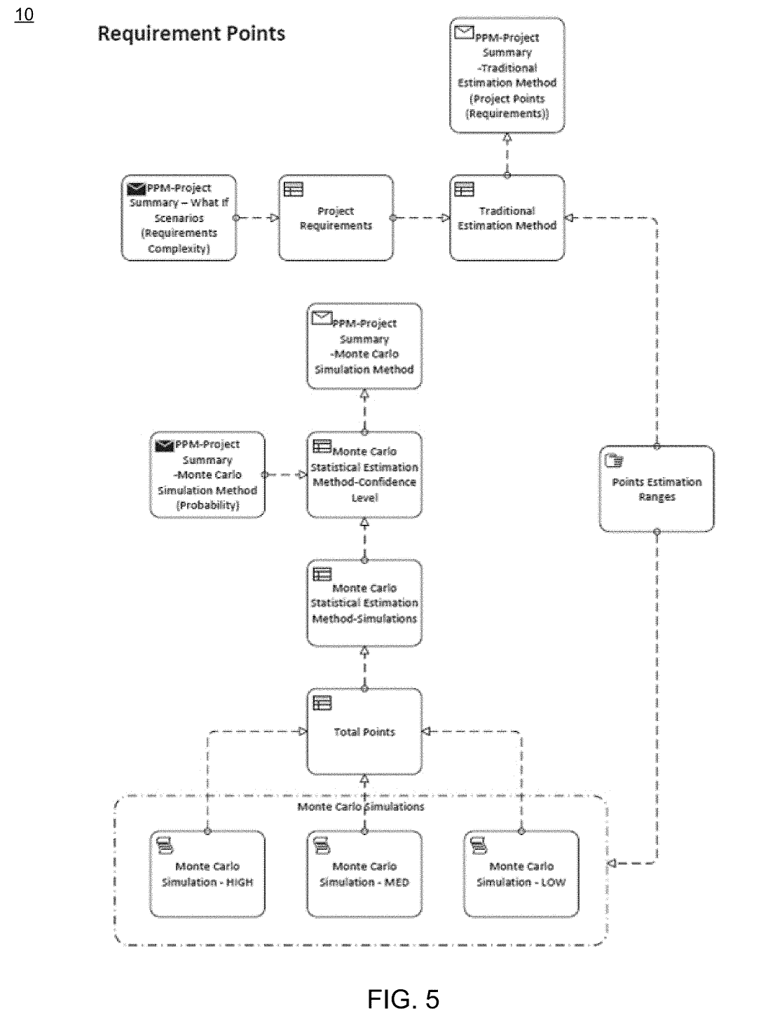

In some embodiments and referring also to the example of FIG. 5, software development process 10 may generate 202 a plurality of possible results for the requirement points development factor estimated to complete the software development project based upon, at least in part, the plurality of development requirements for the software development project and generate 204 a plurality of results for the requirement points development factor estimated to complete the software development project including processing a different set of random values from the plurality of possible results for the requirement points development factor estimated to complete the software development project during each iteration of a plurality of iterations of one or more probabilistic models. For example, in response to receiving the plurality of development requirements (e.g., number of project requirements by complexity type, the estimated points for each requirement complexity by likelihood of occurrence, likelihood of occurrence for best case, expected case, and worst case points estimates, and/or a received confidence level) as shown in FIGS. 3 and 5, software development process 10 may generate the plurality of possible results for the requirement points development factor and generate 204 the plurality of results for the requirement points development factor. In some embodiments, and as will be discussed in greater detail below, software development process 10 may provide 206 the plurality of results for the requirement points development factor, where the results may include, but are not limited to, a total estimated number of points associated with the development requirements received 200 from the user.

In some embodiments, the total number of points associated with the development requirements may be in accordance with a received 208 confidence level. This approach normalizes the Agile point structure using the Fibonacci scale. For example, the Fibonacci sequence consists of numbers that are the summation of the two preceding numbers, starting with [0, 1]. Agile methodology may use the Fibonacci sequence to achieve better results by reducing complexity, effort, and doubt when determining the development time required for a task. By doing so, software development process 10 may allow developers and a software development team to accurately reflect hours of development in a comprehensive and time bound approach.

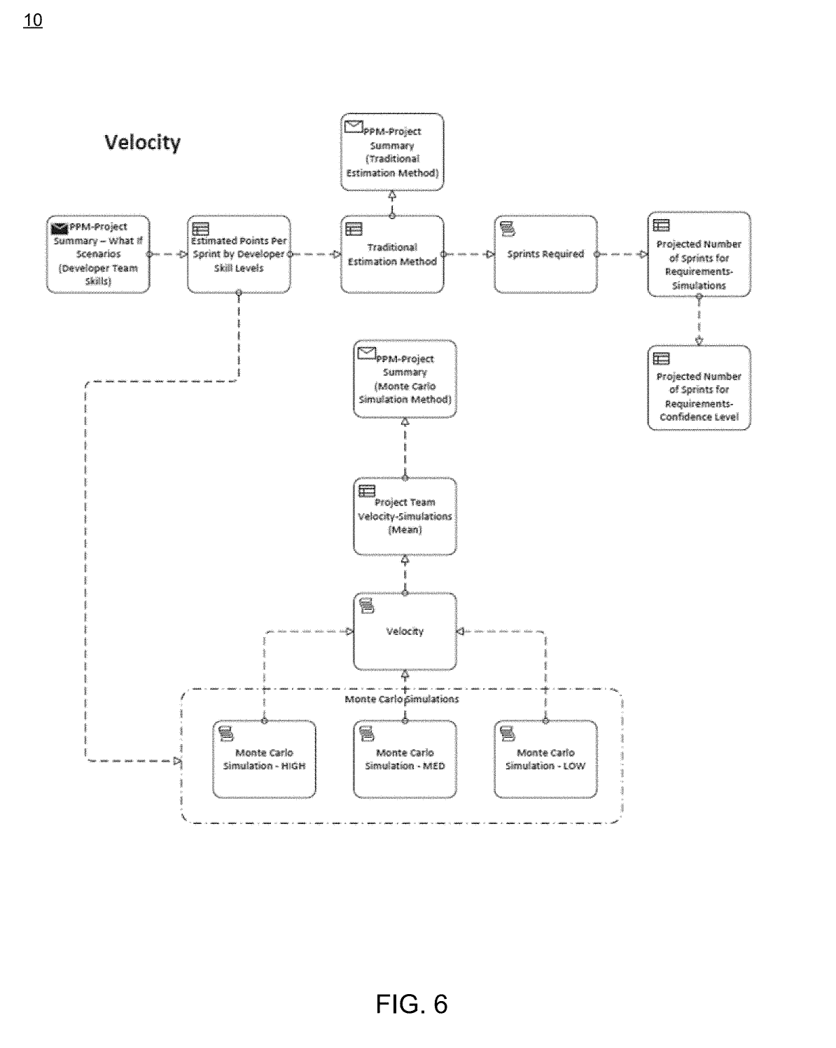

In some embodiments and referring also to the example of FIG. 6, software development process 10 may generate 202 a plurality of possible results for velocity development factor estimated to complete the software development project based upon, at least in part, the plurality of development requirements for the software development project and generate 204 a plurality of results for the velocity development factor estimated to complete the software development project including processing a different set of random values from the plurality of possible results for the velocity development factor estimated to complete the software development project during each iteration of a plurality of iterations of one or more probabilistic models. For example, in response to receiving the plurality of development requirements (e.g., number of developers by skill level and/or a range of points that can be completed in a sprint by developers in each skill level) as shown in FIGS. 3 and 6, software development process 10 may generate the plurality of possible results for the velocity development factor and generate 204 the plurality of results for the velocity development factor. In some embodiments, and as will be discussed in greater detail below, software development process 10 may provide 206 the plurality of results for the velocity development factor, where the results may include, but are not limited to, a sprint velocity for the development team (e.g., a mean and standard deviation). Number of developers by skill level (advanced, intermediate and basic) Range (high and low values) of points that can be completed in a sprint by developers in each skill level (advanced, intermediate and basic) and a range defined for each. From these weights, the model established a Sprint velocity for the team (mean and standard deviation).

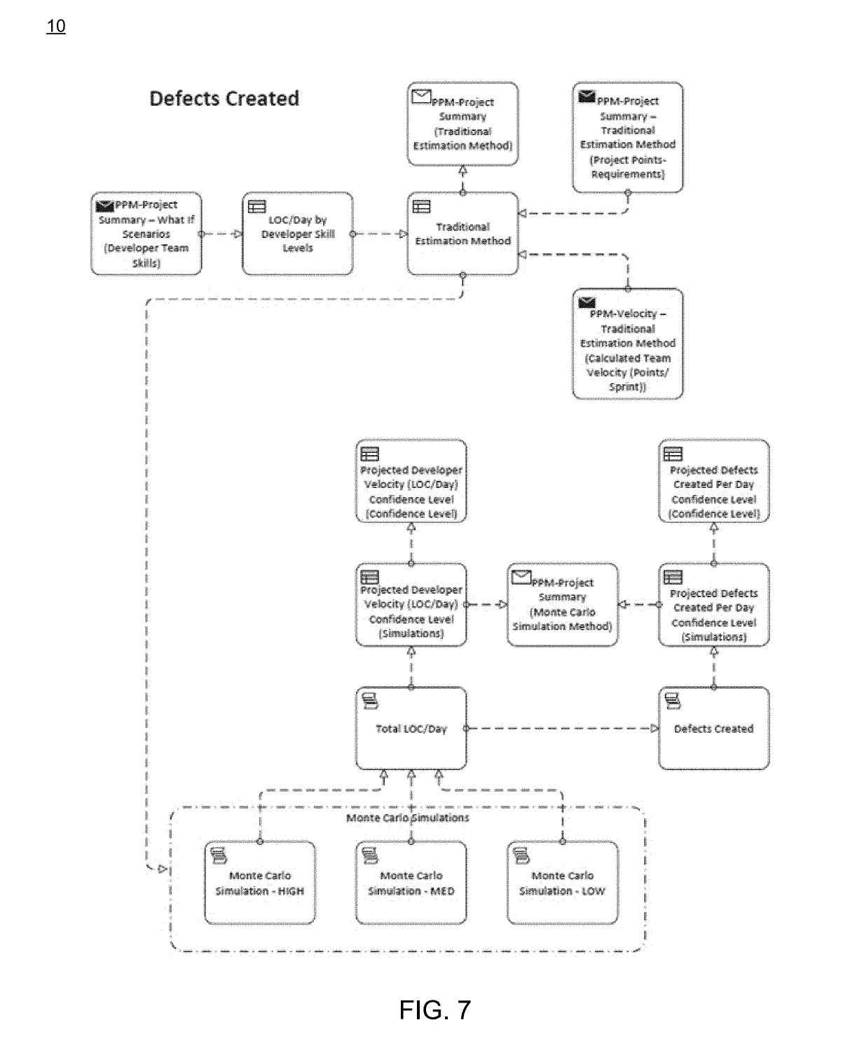

In some embodiments and referring also to the example of FIG. 7, software development process 10 may generate 202 a plurality of possible results for the defects created development factor estimated to complete the software development project based upon, at least in part, the plurality of development requirements for the software development project and generate 204 a plurality of results for the defects created development factor estimated to complete the software development project including processing a different set of random values from the plurality of possible results for the defects created development factor estimated to complete the software development project during each iteration of a plurality of iterations of one or more probabilistic models. For example, in response to receiving the plurality of development requirements (e.g., number of developers by skill level, a range of points that can be completed in a sprint by developers in each skill level, and/or a range of defects produced per 1000 lines of code (LOCs)) as shown in FIGS. 3 and 7, software development process 10 may generate the plurality of possible results for the defects created development factor and generate 204 the plurality of results for the defects created development factor. In some embodiments, and as will be discussed in greater detail below, software development process 10 may provide 206 the plurality of results for the defects created development factor, where the results may include, but are not limited to, projected team velocity in terms of number of lines of code produced (e.g., mean and standard deviation) per time period (e.g., per day), projected number of defects created (e.g., mean and standard deviation) per time period (e.g., per day) for the development team, number of developers by skill level (e.g., advanced, intermediate, and/or basic), and/or a range (e.g., high and low values) of number of lines of code that can be produced per day by developers in each skill level (advanced, intermediate and basic) and the range (high and low values) of defects produced per 1000 lines of code.

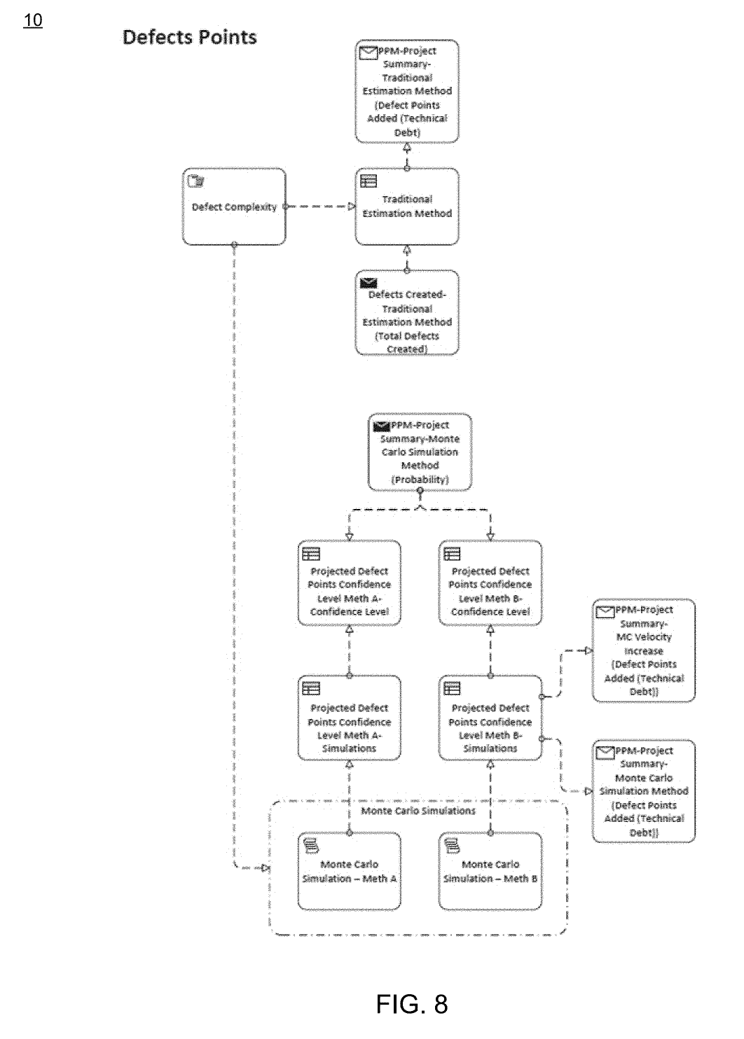

In some embodiments and referring also to the example of FIG. 8, software development process 10 may generate 202 a plurality of possible results for the defects points development factor estimated to complete the software development project based upon, at least in part, the plurality of development requirements for the software development project and generate 204 a plurality of results for the defects points development factor estimated to complete the software development project including processing a different set of random values from the plurality of possible results for the defects points development factor estimated to complete the software development project during each iteration of a plurality of iterations of one or more probabilistic models. For example, in response to receiving the plurality of development requirements (e.g., number of project requirements by complexity type, the estimated points for each requirement complexity by likelihood of occurrence and/or likelihood of occurrence for best case, expected case, and worst case points estimates) as shown in FIGS. 3 and 8, software development process 10 may generate the plurality of possible results for the defects points development factor and generate 204 the plurality of results for the defects points development factor. In some embodiments, and as will be discussed in greater detail below, software development process 10 may provide 206 the plurality of results for the defects points development factor (e.g., number of points associated with a defect (e.g., mean and standard deviation)). In some embodiments and based on the seniority of each developers, software development process 10 may anticipate a specific number of defect point added to the backlog for further grooming. In some embodiments, software development process 10 may provide or determine an estimated number of points for each defect complexity type (e.g., high, medium and low) by likelihood of occurrence with addition to Total project points for both requirements and defects.

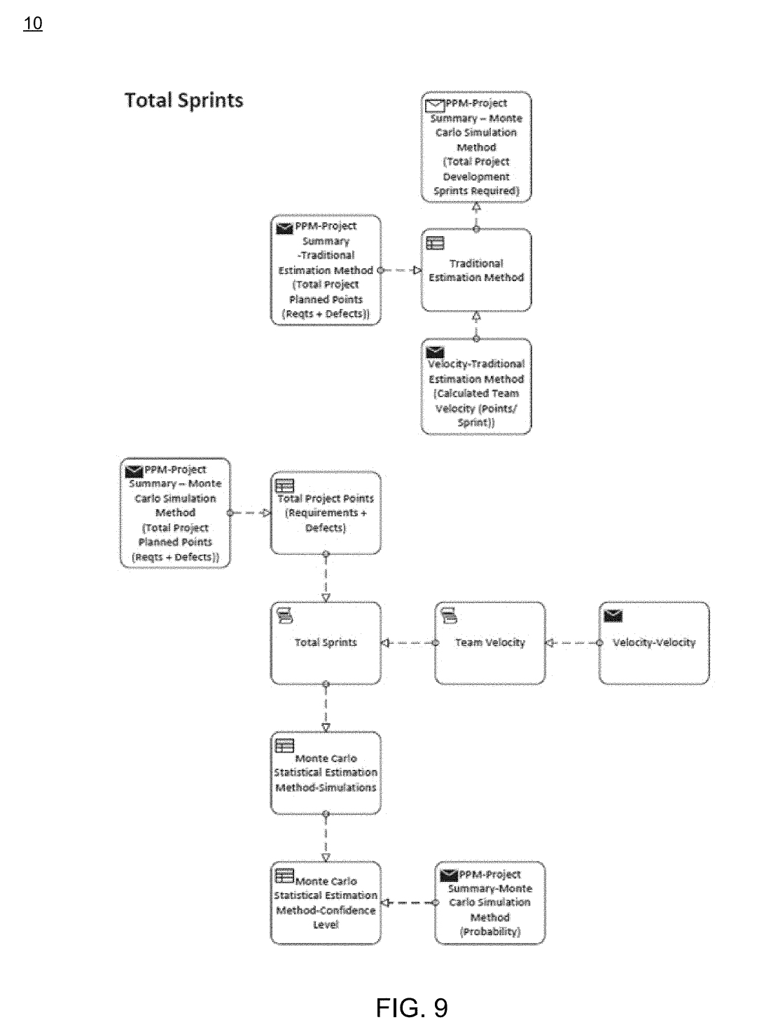

In some embodiments and referring also to the example of FIG. 9, software development process 10 may generate 202 a plurality of possible results for the total sprints development factor estimated to complete the software development project based upon, at least in part, the plurality of development requirements for the software development project and generate 204 a plurality of results for the total sprints development factor estimated to complete the software development project including processing a different set of random values from the plurality of possible for the total sprints development factor estimated to complete the software development project during each iteration of a plurality of iterations of one or more probabilistic models. For example, in response to receiving the plurality of development requirements, the results for the requirement points development factor, the results for the velocity development factor, and/or the received confidence level as shown in FIGS. 3 and 9, software development process 10 may generate the plurality of possible results for the total sprints development factor and generate 204 the plurality of results for the total sprints development factor. In some embodiments, and as will be discussed in greater detail below, software development process 10 may provide 206 the plurality of results for the total sprints development factor (e.g., number of sprints required to achieve the requirement points development factor). In some embodiments, the total number of points associated with the development requirements may be based upon, at least in part, the received 208 confidence level.

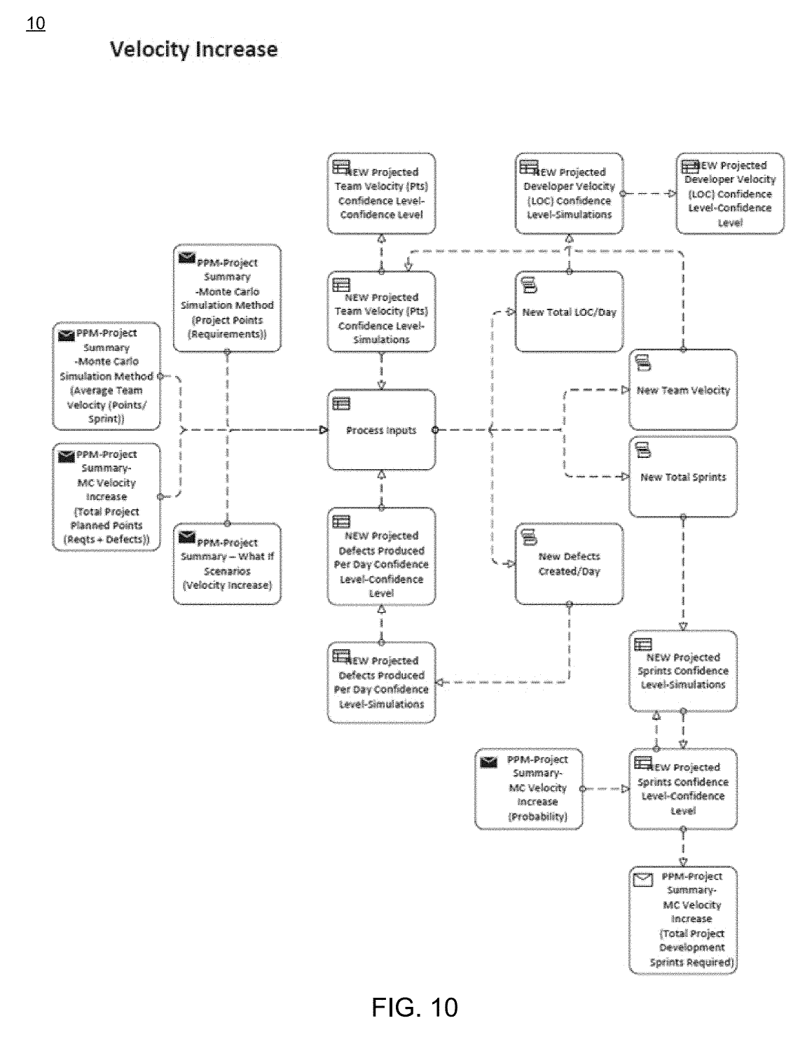

In some embodiments and referring also to the example of FIG. 10, software development process 10 may generate 202 a plurality of possible results for velocity increase development factor estimated to complete the software development project based upon, at least in part, the plurality of development requirements for the software development project and generate 204 a plurality of results for the velocity increase development factor estimated to complete the software development project including processing a different set of random values from the plurality of possible for the velocity increase development factor estimated to complete the software development project during each iteration of a plurality of iterations of one or more probabilistic models. For example, in response to receiving the plurality of development requirements, the results for the requirement points development factor, the results for the velocity development factor, the results of the total sprints development factor, the results of the defects created development factor, and/or the received confidence level as shown in FIGS. 3 and 10, software development process 10 may generate the plurality of possible results for the velocity increase development factor and generate 204 the plurality of results for the velocity increase development factor. In some embodiments, the results for the velocity increase development factor may be used to provide data for “burn down”/“burn up” against backlog and developer proficiency.

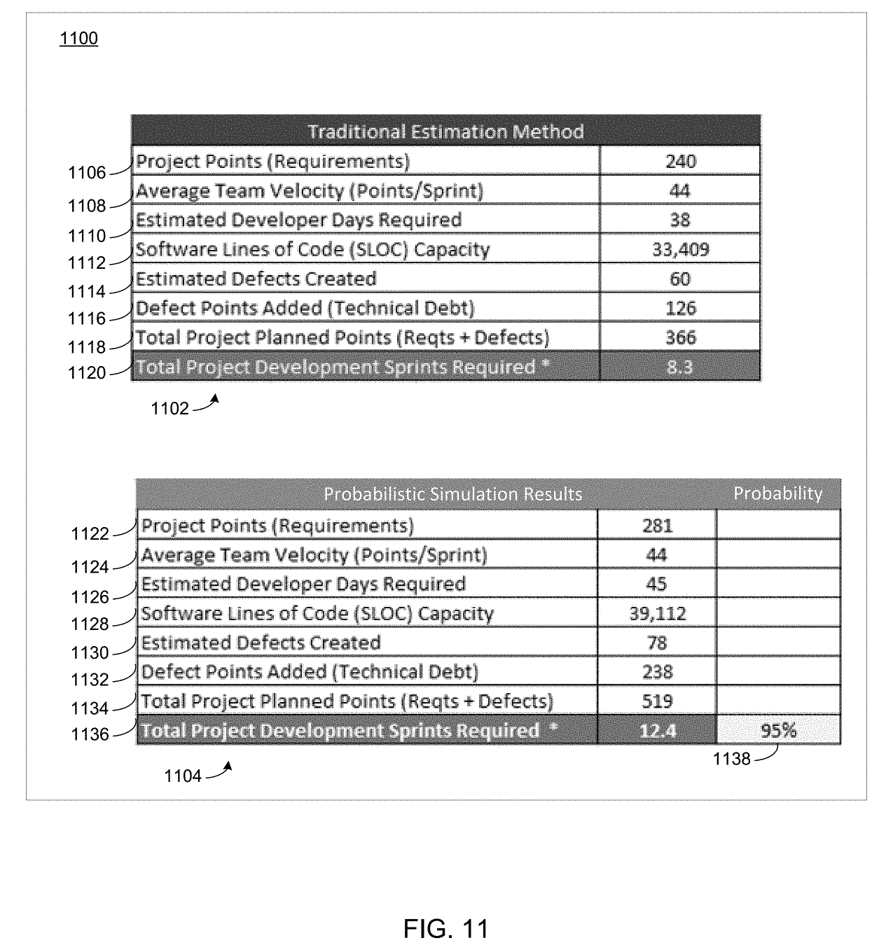

In some implementations, software development process 10 may provide 206 the plurality of results for the one or more development factors estimated to complete the software development project in a user interface of the computing device. Referring also to FIG. 11 and in response to generating 204 the plurality of results for the one or more development factors estimated to complete the software development project, software development process 10 may provide 206 the plurality of results for the one or more development factors estimated to complete the software development project in a user interface (e.g., user interface 1100). In some embodiments, software development process 10 may provide 206 the results for the one or more development factors based on traditional or conventional estimation methods (e.g., traditional estimation method results 1102) and results for the one or more development factors generated 204 based upon, at least in part, the processing a different set of random values from the plurality of possible results for the one or more development factors estimated to complete the software development project during each iteration of a plurality of iterations of one or more probabilistic models (e.g., probabilistic simulation results 1104).

In some embodiments and as can be seen in the example of FIG. 11, software development process 10 may provide results for the one or more development factors (e.g., project points 1106, 1122; average team velocity 1108, 1124; estimated developed days required 1110, 1126; software lines of code (SLOC) capacity 1112, 1128; estimated defects created 1114, 1130; defect points added 1116, 1132; total project planned points 1118, 1134; and total sprints 1120, 1136) for each of the traditional estimation method results 1102 and the probabilistic simulation results 1104. As can be seen from FIG. 11, the results for the one or more development factors as shown in the probabilistic simulation results 1104 are more conservative than the traditional estimation method results 1102. In some embodiments and as discussed above, software development process 10 may receive 208 a level of confidence (e.g., level of confidence 1138) associated with the results for the one or more development factors. As discussed above, software development process 10 may provide 206 a plurality results for the one or more development factors in accordance with the received level of confidence (e.g., level of confidence 1138). Accordingly, a user utilizing software development process 10 may be provided 206 with results that are more accurate than those of traditional estimation methods and with results that are in accordance with a defined level of confidence.

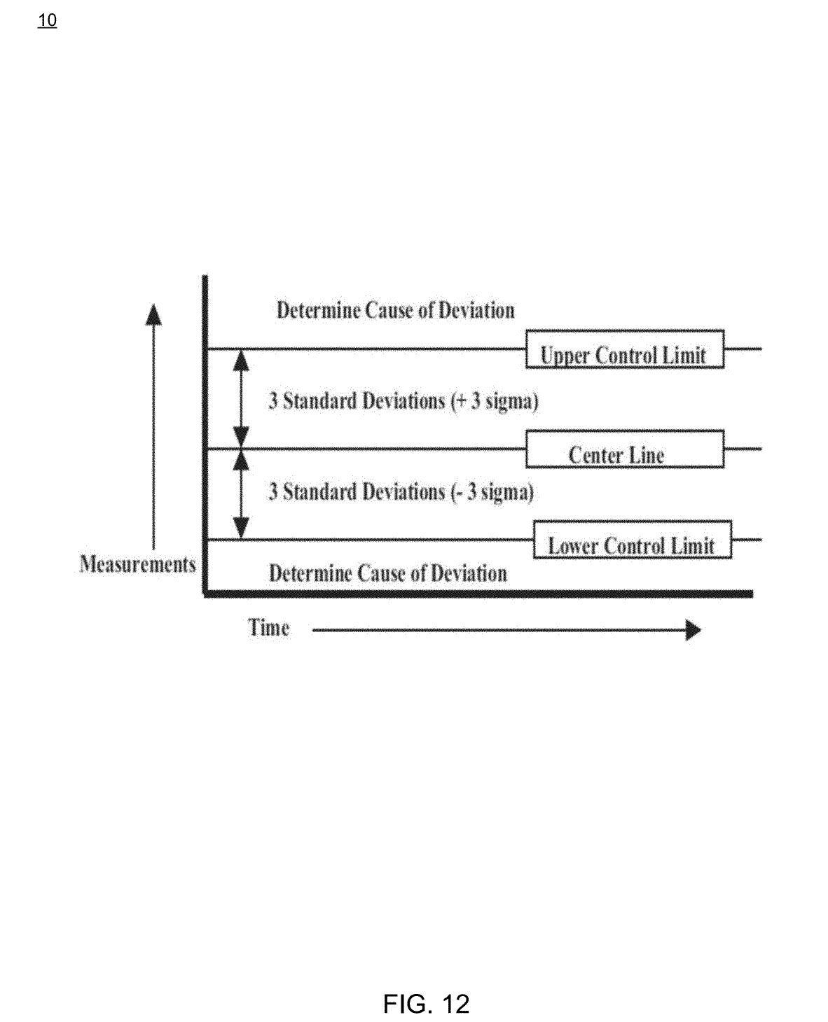

In some embodiments and referring also to the example of FIG. 12, software development process 10 may define 212 one or more of a lower control limit and an upper control limit based upon, at least in part, historical software development project data. In some embodiments, a lower control limit and/or an upper control limit may be defined 212 for each control chart (as shown in FIG. 12). For example, software development process 10 may define a process performance baseline (PPB). In some embodiments, a PPB may be a documented characterization of the actual results achieved by following a process. Process performance baselines are derived by analyzing the collected measures of historical, completed projects in the organization to establish a distribution and range of results that characterize the expected performance for selected processes when used on an active project in the organization. In some embodiments, PPBs may be used by software development process 10 as a benchmark for comparing actual process performance against expected process performance (measure of the results of following a process). For example, using the PPB historical averages, upper, and lower control limits along with user entered data, software development process 10 may statistically predict outcomes of certain agile software development metrics whereby the user can use for planning, with a level of confidence set by the user (e.g., 80% or 90% certainty), by which the project will successfully complete. These outcomes may include the total points the user should plan the project to, including points associated with the requirements, the number of defects expected to be created and points associated with those defects. In addition, the user may perform “what if” analyses to determine how the results if the staffing mix is changed (e.g., adding a developer), the requirements mix is different (e.g., if some of the medium complexity requirements should be classified as high complexity), or if the user wants to push the team to achieve higher velocities during the sprints (e.g., to try to finish earlier).

In some embodiments, software development process 10 may collect and analyze data from several completed agile software development projects to develop PPBs (e.g., historical software development project data). For example, historical software development projects may be selected due to their similarity in project performance and objectives as well as availability of historical metric data. Other projects may not be selected due to lack of availability of the desired data to be collected. The data collected and analyzed from these historical projects may generally include, but is not limited to: total project requirements; total revisions/changes to the project requirements; total project points; points completed at specific project durations (i.e., 25%, 50%, 75% and 100%); number of developers assigned to the project; average points completed in a sprint; software lines of code (SLOC) produced; total number of defects created during the project; total number of pages in a software design document (SDD); total number of peer review comments on the SDD; and/or total number of client review comments on the SDD. It will be appreciated that other historical software development project data may be collected.

Software development process 10 may quantitatively analyze the historical project data in accordance with the project life cycle phases of requirements, development, testing and documentation using statistical methods resulting in data tables and control charts. In some embodiments, this methodology may use statistical analysis to calculate central tendencies (i.e., average or mean value) and variation (i.e., upper and lower control limits) in performance. Three standard deviations may be used to define its upper and lower control limits because, per the normal distribution, 99% of all normal random values lie within e.g., +/− three standard deviations from the normal. In other words, if a process is mature and under statistical process or project control, all process events should lie within the upper and lower control limits. If a process' events fall outside the control limits, the process is said to be out of statistical process control and the reason for this process behavior needs to be investigated and actions taken to bring the process back into control. As will be discussed in greater detail below, Use of Control Charts provided by software development process 10 may graphically enable users to identify undesirable trends and point out fixable problems and potential process improvements as shown in FIG. 12.

Using the above-described methodology, software development process 10 may develop e.g., five PPBs: requirements quality and volatility (e.g., stability of requirements and level of churn); completion at specified durations (e.g., adherence to plan/schedule); developer velocity (e.g., developer skill); defect density of application code (e.g., quality of code); quality of deliverables (e.g., document quality). For each PPB, an upper control limit (UCL), a historical average (i.e., center line) and a lower control limit (LCL) values may be calculated. While five PPBs have been discussed, it will be appreciated that any number of PPBs may be developed or generated within the scope of the present disclosure. A sample table of these values is provided in Table 1 below:

TABLE 1

| PPB | Measurement | UCL | Average | LCL |
|---|---|---|---|---|
| Requirement | Changes Per | 274.3 | 209.0 | 143.8 |
| Volatility | 100 | | | |
| | Requirements | | | |
| Completion at | Points | 20.2 | 14.7 | 6.1 |
| 25% Duration | Completed | | | |
| | Percent | 30.4% | 14.9% | 0.7% |
| | Completed | | | |
| Completion at | Points | 53.2 | 43.6 | 34.1 |
| 25% Duration | Completed | | | |
| | Percent | 74% | 44.6% | 15.3% |
| | Completed | | | |
| Completion at | Points | 87.2 | 74.7 | 62.2 |
| 25% Duration | Completed | | | |
| | Percent | 101.7% | 74.7% | 47.0% |
| | Completed | | | |
| Completion at | Points | 111.6 | 97.3 | 83 |
| 25% Duration | Completed | | | |
| | Percent | 117.4% | 96.5% | 75.7% |
| | Completed | | | |
| Developer | Points/Sprint | 21.0 | 14.4 | 7.8 |
| Velocity | | | | |
| Defects | Defects Per | 2.1 | 1.8 | 1.4 |
| Created | 1000 SLOC | | | |
| Document Peer | Comments Per | 70.9 | 38.4 | 12.3 |
| Review | 100 Pages | | | |
| Document | Comments Per | 114.7 | 70.6 | 29.3 |
| Client Review | 100 Pages | | | |

In some embodiments, developed PPBs may evolve as additional projects reach completion, where data associated with these newly closed projects may be collected by software development process 10 to augment the existing data. Additional PPBs may be implemented based on ongoing experience (e.g., newly identified metrics of interest) and desire for continual improvement. For example, PPBs may be developed or generated for defect points, requirement points, and/or defect density baseline by subsystem and category.

Using the PPB historical averages, upper, and lower control limits along with user-entered data, software development process 10 may statistically predict or estimate results or outcomes of certain agile software development metrics (e.g., one or more development factors) whereby the user (e.g., project manager) can use for planning, with a level of confidence set by the user (e.g., project manager) (e.g., 80% or 90% certainty), by which the project will successfully complete. In some embodiments, these results or outcomes for the one or more development factors estimated to complete the software development project may include the total points the user (e.g., project manager) should plan the project to include, including points associated with the requirements, the number of defects expected to be created and points associated with those defects. In addition, the user (e.g., project manager) may perform “what if” analyses to determine how the results if e.g., the staffing mix is changed (e.g., adding a developer), e.g., the requirements mix is different (e.g., if some of the medium complexity requirements should be classified as high complexity), and/or if the user (e.g., project manager) wants to push the team to achieve higher velocities during the sprints (e.g., to try to finish earlier).

In some embodiments, software development process 10 may provide a single, consolidated source of all information associated with the agile software development project that enables the user (e.g., project manager) to effectively monitor and track performance of project. Software development process 10 may enable the user (e.g., project manager) to document planning performed (e.g., using a user interface provided by software development process 10), document project results sprint-by-sprint, analyze results against historical norms (i.e., PPBs), determine the need for re-planning or what if analysis, and document the analysis results and decisions made (including any corrective actions). In this way, software development process 10 may incorporate the PPBs in its implementation and may support at least one or more of the following agile software development lifecycle process areas:
Requirements Volatility
Development Performance
Schedule Performance
Defects Produced
Documentation Quality

In some embodiments, a user (e.g., a project manager) may provide software development process 10 with one or more of the following development factor measurements for one or more sprints during execution of the software development project:
Total number of requirements (if it changed during the sprint)
Number of changed/edited requirements
Actual sprint velocity
Number of lines of code produced
Number of defects created
Total number pages in the document draft
Number of peer review and client review comments

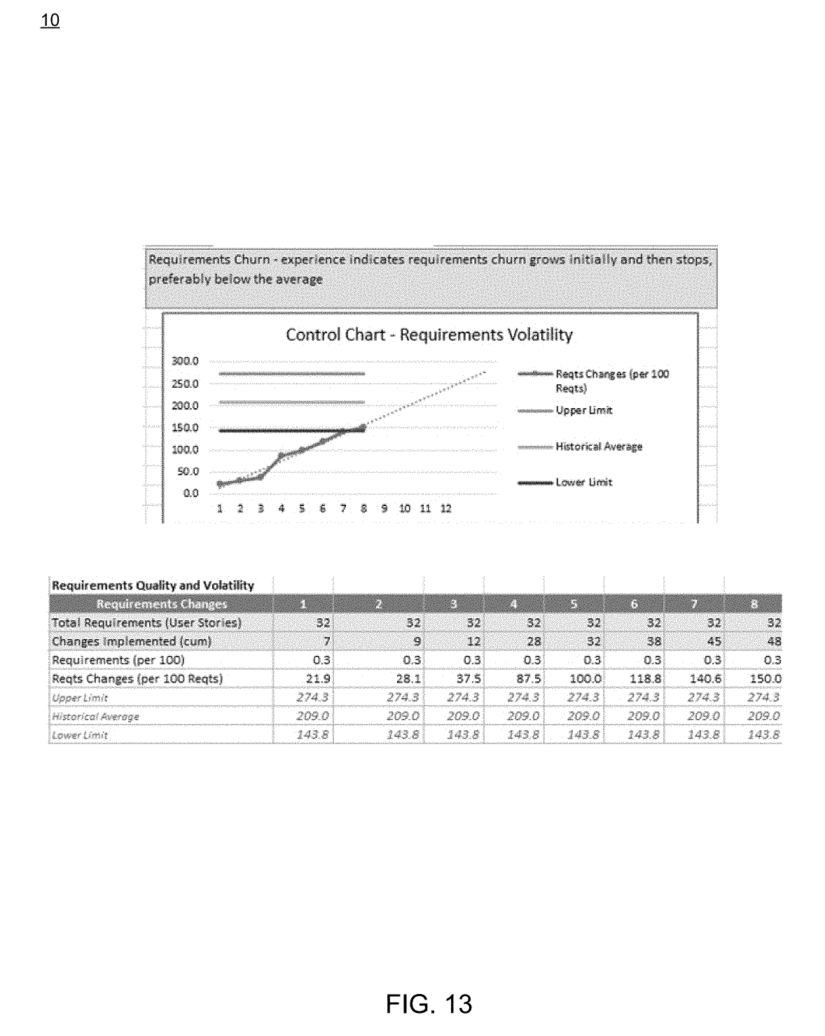

In some embodiments, software development process 10 may provide one or more graphs and PPB control charts that may aid the user (e.g., project manager) in analyzing project performance and status. The PPB control charts may be incorporated into a user interface to enable users to compare project performance to historical norms. In some embodiments and referring also to FIG. 13, the PPB values may be shown in both the data tables and/or as control charts to aid in comparing current project performance against the historical PPBs. In some embodiments, graphs and control charts provided 206 by software development process 10 may organized by project performance and/or team performance. The project performance graphs and control charts may include one or more of: planned vs actual burn up (points); estimated total points at completion; actual points burn up at defined development time intervals (i.e., 25%, 50%, 75% and 100% duration); and/or percent complete at defined development time intervals (i.e., 25%, 50%, 75% and 100% duration).

In some embodiments, the team performance graphs and control charts provided by software development process 10 may include one or more of: sprint velocity; average developer velocity; defect density; requirements volatility; documentation peer review comments; and/or documentation client review comments.

In some embodiments, the user (e.g., project manager) may review and assess the data shown in the graphs and control charts to determine if the project is performing within acceptable norms and on schedule. In some embodiments, software development process 10 may provide an area for a user to document the analysis results of the project's performance and any decisions made (e.g., the need to re-plan the project or take corrective actions).

In some embodiments, software development process 10 may receive 214 one or more revised development requirements in response to providing the plurality of results for the one or more development factors estimated to complete the software development project in the user interface of the computing device. For example and referring also to FIG. 11, suppose the results provided 206 to the user (e.g., probabilistic simulation results 1104) include one or more development factors (e.g., total project development sprints required 1136) that exceeds a pre-defined threshold (e.g., 12 total sprints). In some implementations, software development process 10 may receive 214 one or more revised development requirements in response to providing 206 the results for the one or more development factors that exceed the pre-defined threshold. As discussed above, software development process 10 may allow re-planning of the software development project by generating 216 a plurality of revised possible results for each of the one or more development factors estimated to complete the software development project based upon, at least in part, the plurality of revised development requirements for the software development project, generating 218 a plurality of revised results for the one or more development factors estimated to complete the software development project including processing a different set of random values from the plurality of revised possible results for the one or more development factors estimated to complete the software development project during each iteration of the plurality of iterations of the one or more probabilistic models, and providing 220 the plurality of revised results for the one or more development factors estimated to complete the software development project in the user interface of the computing device.

In another example, software development process 10 may receive one or more actual development factor results during execution of the software development project. For example, a user may provide actual results from the software development project and software development process 10 may generate the one or more graphs and/or control charts to compare the actual development factors to the generated 204 plurality of results for the one or more development factors estimated to complete the software development project. In some embodiments, software development process 10 may warn or provide a notification to a user when the actual development factor results are beyond the upper control and/or lower control limit for the software development project. In this manner, software development process 10 may allow re-planning of the software development project. For example and in response to software development process 10 notifying a user that the one or more development factors are beyond the upper control limit and/or the lower control limit, software development process 10 may receive 214 one or more revised development requirements in response to providing the plurality of results for the one or more development factors estimated to complete the software development project in the user interface of the computing device. As discussed above software development process 10 may allow re-planning of the software development project by generating 216 a plurality of revised possible results for each of the one or more development factors estimated to complete the software development project based upon, at least in part, the plurality of revised development requirements for the software development project, generating 218 a plurality of revised results for the one or more development factors estimated to complete the software development project including processing a different set of random values from the plurality of revised possible results for the one or more development factors estimated to complete the software development project during each iteration of the plurality of iterations of the one or more probabilistic models, and providing 220 the plurality of revised results for the one or more development factors estimated to complete the software development project in the user interface of the computing device. In this manner, software development process 10 may allow a user (e.g., project manager) to be notified of potential shortcomings in a software development project and allow the user to re-plan the software development project.

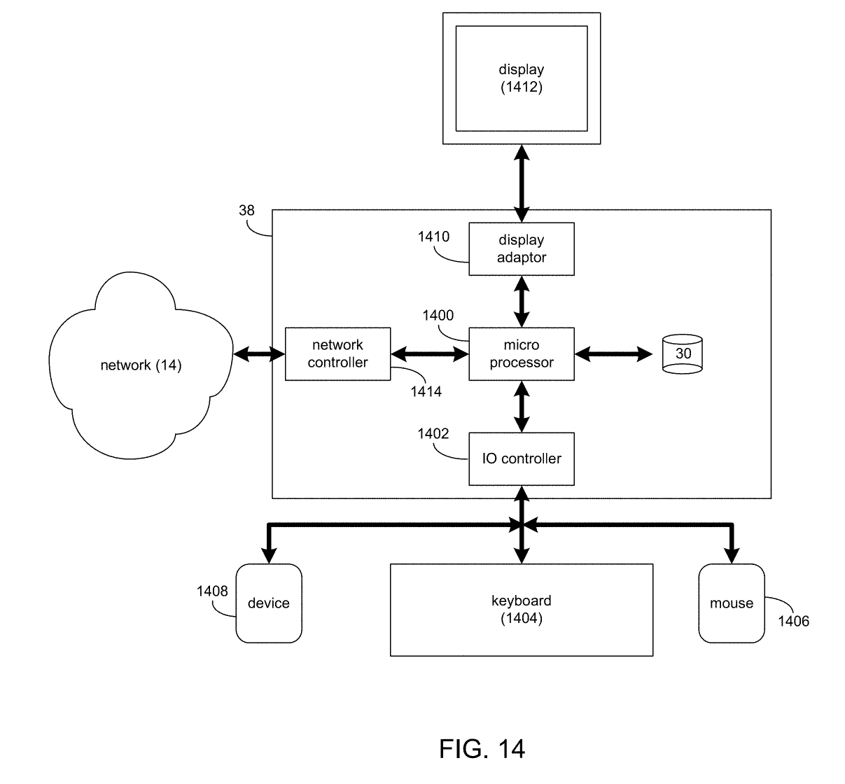

Referring also to the example implementation of FIG. 14, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, software development process 10 may be substituted for client electronic device 38 (in whole or in part) within FIG. 1, examples of which may include but are not limited to computer 12 and/or one or more of client electronic devices 40, 42, 44.

In some implementations, client electronic device 38 may include a processor (e.g., microprocessor 1400) configured to, e.g., process data and execute the above-noted code/instruction sets and subroutines. Microprocessor 1400 may be coupled via a storage adaptor to the above-noted storage device(s) (e.g., storage device 30). An I/O controller (e.g., I/O controller 1402) may be configured to couple microprocessor 1400 with various devices (e.g., via wired or wireless connection), such as keyboard 1406, pointing/selecting device (e.g., touchpad, touchscreen, mouse 1408, etc.), custom device (e.g., device 1415), USB ports, and printer ports. A display adaptor (e.g., display adaptor 1410) may be configured to couple display 1412 (e.g., touchscreen monitor(s), plasma, CRT, or LCD monitor(s), etc.) with microprocessor 1400, while network controller/adaptor 1414 (e.g., an Ethernet adaptor) may be configured to couple microprocessor 1400 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, at a computing device, a plurality of development requirements of a software development project;
generating a plurality of possible results for each of one or more development factors estimated to complete the software development project based upon, at least in part, the plurality of development requirements for the software development project;
generating a plurality of results for the one or more development factors estimated to complete the software development project including processing a different set of random values from the plurality of possible results for the one or more development factors estimated to complete the software development project during each iteration of a plurality of iterations of one or more probabilistic models; and
providing the plurality of results for the one or more development factors estimated to complete the software development project in a user interface of the computing device.

2. The computer-implemented method of claim 1, further comprising:
receiving one or more revised development requirements in response to providing the plurality of results for the one or more development factors estimated to complete the software development project in the user interface of the computing device;
generating a plurality of revised possible results for each of the one or more development factors estimated to complete the software development project based upon, at least in part, the plurality of revised development requirements for the software development project;
generating a plurality of revised results for the one or more development factors estimated to complete the software development project including processing a different set of random values from the plurality of revised possible results for the one or more development factors estimated to complete the software development project during each iteration of the plurality of iterations of the one or more probabilistic models; and
providing the plurality of revised results for the one or more development factors estimated to complete the software development project in the user interface of the computing device.

3. The computer-implemented method of claim 1, wherein the one or more development factors estimated to complete the software development project include one or more of: requirements points, velocity, defects created, defect points, total sprints, and velocity increase.

4. The computer-implemented method of claim 1, further comprising:
defining one or more of a lower control limit and an upper control limit based upon, at least in part, historical software development project data.

5. The computer-implemented method of claim 1, further comprising:
receiving a minimum level of confidence associated with completing the software development project for a set of development factors estimated to complete the software development project based upon, at least in part, the plurality of development requirements for the software development project; and
generating the plurality of results for the one or more development factors estimated to complete the software development project based upon, at least in part, the minimum level of confidence associated with completing the software development project with the set of development factors.

6. The computer-implemented method of claim 1, wherein the one or more probabilistic models include one or more Monte Carlo simulations.

7. A computer program product residing on a non-transitory computer readable storage medium having a plurality of instructions stored thereon which, when executed across one or more processors, causes at least a portion of the one or more processors to perform operations comprising:
receiving a plurality of development requirements of a software development project;
generating a plurality of possible results for each of one or more development factors estimated to complete the software development project based upon, at least in part, the plurality of development requirements for the software development project;
generating a plurality of results for the one or more development factors estimated to complete the software development project including processing a different set of random values from the plurality of possible results for the one or more development factors estimated to complete the software development project during each iteration of a plurality of iterations of one or more probabilistic models; and
providing the plurality of results for the one or more development factors estimated to complete the software development project in a user interface of a computing device.

8. The computer program product of claim 8, further comprising instructions for:
receiving one or more revised development requirements in response to providing the plurality of results for the one or more estimate development factors estimated to complete the software development project in the user interface of the computing device;
generating a plurality of revised possible results for each of the one or more development factors estimated to complete the software development project based upon, at least in part, the plurality of revised development requirements for the software development project;
generating a plurality of revised results for the one or more development factors estimated to complete the software development project including processing a different set of random values from the plurality of revised possible results for the one or more development factors estimated to complete the software development project during each iteration of the plurality of iterations of the one or more probabilistic models; and
providing the plurality of revised results for the one or more development factors estimated to complete the software development project in the user interface of the computing device.

9. The computer program product of claim 8, wherein the one or more development factors estimated to complete the software development project include one or more of: requirements points, velocity, defects created, defect points, total sprints, and velocity increase.

10. The computer program product of claim 8, further comprising instructions for:
defining one or more of a lower control limit and an upper control limit based upon, at least in part, historical software development project data.

11. The computer program product of claim 8, further comprising instructions for:
receiving a minimum level of confidence associated with completing the software development project with a set of development factors estimated to complete the software development project based upon, at least in part, the plurality of development requirements for the software development project; and
generating the plurality of results for the one or more development factors estimated to complete the software development project based upon, at least in part, the minimum level of confidence associated with completing the software development project with the set of development factors.

12. The computer program product of claim 8, wherein the one or more probabilistic models include one or more Monte Carlo simulations.

13. A computing system including one or more processors and one or more memories configured to perform operations comprising:
receiving a plurality of development requirements of a software development project;
generating a plurality of possible results for each of one or more development factors estimated to complete the software development project based upon, at least in part, the plurality of development requirements for the software development project;
generating a plurality of results for the one or more development factors estimated to complete the software development project including processing a different set of random values from the plurality of possible results for the one or more development factors estimated to complete the software development project during each iteration of a plurality of iterations of one or more probabilistic models; and
providing the plurality of results for the one or more development factors estimated to complete the software development project in a user interface of a computing device.

14. The computing system of claim 15, wherein the operations further comprise:
receiving one or more revised development requirements in response to providing the plurality of results for the one or more estimate development factors estimated to complete the software development project in the user interface of the computing device;
generating a plurality of revised possible results for each of the one or more development factors estimated to complete the software development project based upon, at least in part, the plurality of revised development requirements for the software development project;
generating a plurality of revised results for the one or more development factors estimated to complete the software development project including processing a different set of random values from the plurality of revised possible results for the one or more development factors estimated to complete the software development project during each iteration of the plurality of iterations of the one or more probabilistic models; and
providing the plurality of revised results for the one or more development factors estimated to complete the software development project in the user interface of the computing device.

15. The computing system of claim 16, wherein the one or more development factors estimated to complete the software development project include one or more of: requirements points, velocity, defects created, defect points, total sprints, and velocity increase.

16. The computing system of claim 16, wherein the operations further comprise:
defining one or more of a lower control limit and an upper control limit based upon, at least in part, historical software development project data.

17. The computing system of claim 15, wherein the operations further comprise:
receiving a minimum level of confidence associated with completing the software development project with a set of development factors estimated to complete the software development project based upon, at least in part, the plurality of development requirements for the software development project; and
generating the plurality of results for the one or more development factors estimated to complete the software development project based upon, at least in part, the minimum level of confidence associated with completing the software development project with the set of development factors.

18. The computing system of claim 15, wherein the one or more probabilistic models include one or more Monte Carlo simulations.
